(19) United States
(12) Patent Application Publication
(10) Pub. No.: US 2025/0117552 A1
(43) Pub. Date: Apr. 10, 2025

(54) INVERSE SYSTEM DESIGN FOR CONSTRAINED MULTI-OBJECTIVE OPTIMIZATION

(71) Applicant: The Trustees of Princeton University, Princeton, NJ (US)

(72) Inventors: Prerit TERWAY, Princeton, NJ (US); Niraj K. JHA, Princeton, NJ (US)

(73) Assignee: The Trustees of Princeton University, Princeton, NJ (US)

(21) Appl. No.: 18/799,055

(22) PCT Filed: Feb. 10, 2023
(86) PCT No.: PCT/US2023/012768

§ 371 Date: Aug. 9, 2024

Related U.S. Application Data
(60) Provisional application No. 63/309,091, filed on Feb. 11, 2022.
(60) Provisional application No. 63/327,859, filed on Apr. 6, 2022.
(60) Provisional application No. 63/417,021, filed on Oct. 18, 2022.

(51) Int. Cl. G06F 30/27; G06F 111/06

(52) U.S. Cl. CPC G06F 30/27; G06F 2111/06

(57) ABSTRACT

A design methodology and tool called INFORM are provided that use a two-phase approach for sample-efficient constrained multi-objective optimization of real-world nonlinear systems. In the first optional phase, one may modify a genetic algorithm (GA) to make the design process sample-efficient, and may inject candidate solutions into the GA population using inverse design methods. The inverse design techniques may be based on (i) a neural network verifier, (ii) a neural network, and (iii) a Gaussian mixture model. The candidate solutions for the next generation are thus a mix of those generated using crossover/mutation and solutions generated using inverse design. At the end of the first phase, one obtains a set of nondominated solutions. In the second phase, one chooses one or more solution(s) from the non-dominated solutions or another reference solution to further improve the objective function values using inverse design methods.

### CROSS-REFERENCE TO RELATED APPLICATIONS

This application claims priority to U.S. Provisional Patent Application Nos. 63/309,091 (filed Feb. 11, 2022), 63/327,859 (filed Apr. 6, 2022), and 63/417,021 (filed Oct. 18, 2022), the contents of which are incorporated herein by reference in their entirety.

### STATEMENT REGARDING FEDERALLY SPONSORED RESEARCH OR DEVELOPMENT

This invention was made with government support under Contract No. FA8750-20-C-0025 awarded by the U.S. Air Force and Grant No. HR0011-19-S-0083 awarded by the Defense Advanced Research Projects Agency. The government has certain rights in the invention.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

System design involves selecting system configuration(s) from a design space to solve a constrained multi-objective optimization (CMOO) problem. Using CMOO, one aims to obtain designs that achieve the best value of the objective functions (e.g., power, energy, fuel cost, etc.) while satisfying all constraints on system configuration (e.g., component values) and simulation outputs (e.g., noise, gain, peaking, etc.).

Conventional design techniques often rely on evolutionary algorithms (EAs) to solve CMOO problems. EAs evaluate a diverse set of candidate solutions over multiple generations to avoid local minima. However, EAs are sample-inefficient and require numerous runs to find the best solution to the CMOO problem.

Bayesian optimization (BO) is another widely used sample-efficient system design technique. It uses a surrogate model to actively learn the next candidate solution(s) for simulation. Although BO is sample-efficient, the surrogate model building complexity is O(N³), where N denotes the number of samples.

Furthermore, most existing methods try to find the entire Pareto front (which is typically unknown for a real-world system) rather than focus on specific regions near the set of non-dominated solutions that may be of most interest to the designer. As known in the art, a solution is non-dominated if no other design is better in at least one and better or equal in all other objectives with respect to the given solution.

Therefore, improvements in the field of system design are needed.

### BRIEF SUMMARY

Various deficiencies in the prior art are addressed below by the embodiments disclosed herein.

In some embodiments, a computer-implemented method for performing optimization of a system may be provided. Various system may be optimized; non-limiting examples of such systems to be optimized include systems that utilize one or more electric circuits, such as those used in or in combination with an automotive vehicle, a microchip or integrated circuit, or a component in an electrical grid. In some embodiments, the system for optimization may have a fixed architecture.

The method may include one or more phases. At least one phase may include: (i) receiving a selected reference solution, the selected reference solution including an input and a corresponding output, the selected reference solution being identified as a current best observed solution; (ii) determining or receiving a selection of an objective of the selected reference solution to be improved; (iii) generating and simulating multiple inputs within a first predetermined fraction of the current best observed solution; (iv) training one or more surrogate models using previously determined inputs and system responses; (v) generating a plurality of desired system responses within a second predetermined fraction around the current best observed solution, each desired system response of the plurality of desired system responses improving the objective that was determined or selected in ii), each desired system response of the plurality of desired system responses satisfying existing constraints on the system response; (vi) using one or more of a plurality of inverse design approaches to generate candidate solutions at the desired system response generated in v); (vii) simulating the candidate solutions to provide one or more resulting solutions; (viii) determining if any resulting solutions improve the objective that was determined or selected in ii) and, based on the result, updating the current best observed solution; and (ix) repeating steps iv)-viii).

In some embodiments, the method may include determining if the current best observed solution has improved in a predetermined number of iterations (e.g., 5), and if not, reducing the value of the second predetermined fraction prior to repeating steps iv)-viii). In some embodiments, the method may include determining if the current best observed solution has improved in a predetermined number of iterations (e.g., 10), and if not, reducing the first predetermined fraction and repeating steps iii)-viii). In some embodiments, the method may include terminating the repeating of steps when the current best observed solution has not improved for a predetermined period of time or has not improved for a predetermined number of iterations.

In some embodiments, inverse design-based active learning may include generating a desired system response using Sobol and Latin Hypercube samples to gradually improve quality of resulting solutions, where the desired system response includes objective(s) and/or constraint(s). In some embodiments, candidate solutions within a generation consists of a mixture of solutions generated using crossover/mutation and solutions generated using an inverse design approach of the plurality of inverse design approaches.

In some embodiments, the plurality of inverse design approaches may include a neural network (NN), a NN verifier (NN-Ver), a Gaussian mixture model (GMM), and/or one or more combinations thereof. In some embodiments, an inverse design approach may include specifying a desired system response as outputs of the NN, and determining corresponding inputs after solving a mixed integer linear program formulation of the NN to verify the NN using the NN-Ver. In some embodiments, an inverse design approach may include a NN mapping a system response to system inputs, and wherein candidate solutions are generated by specifying a desired system response as inputs to the NN and determining corresponding NN output, where the system response includes an objective and/or constraint. In some embodiments, an inverse design approach may include considering the joint distribution of values of inputs and corresponding objectives and/or constraints using a GMM, and wherein candidate solutions are generated by computing an expected value of an input given a desired system response. In some embodiments, a probability density function computed of the candidate solutions for the desired system response may be used as a measure of confidence of the solution achieving the desired system response.

In some embodiments, the method may include an initial/first optional phase. This optional phase may include obtaining a set of non-dominated solutions by injecting candidate solutions within a genetic algorithm (GA) using the plurality of inverse design approaches; and generating and simulating a plurality of candidate solutions within a predetermined range of component values. Typically, when an optional phase is used, the selected reference solution for use in the later (second) phase is a candidate solution generated and simulated in the optional (first) phase. In some embodiments, the initial optional phase may be terminated when either: no improvement in extreme values of an objective function is determined for n consecutive generations within the GA after a threshold generation, where n≥2 and the threshold generation ≥2; or the initial optional phase has been executing on one or more processors for more than a threshold period of time. In some embodiments, the initial optional phase may be configured to achieve a higher hypervolume as compared to population based optimization using a NSGA-II algorithm.

In some embodiments, candidate solutions start to be injected when no improvement in extreme values of an objective function is determined for n consecutive generations within the GA, where n≥2.

In some embodiments, the method may include identifying a chosen solution from the one or more resulting solutions and outputting the chosen solution in a format appropriate for implementing the chosen solution. In some embodiments, generating candidate solutions may include simultaneously generating multiple user-specified candidate solutions.

In some embodiments, determining if any resulting solutions improve the objective that was determined or selected in step (ii) includes directly handling multiple objectives and/or constraints based on simulation inputs and outputs, and the determination is free of any use of a pseudometric. In some embodiments, the method may be configured to be performed without the use of any graphical processing unit (GPU). In some embodiments, the method may be configured to drive the reference solution to a different specification. In some embodiments, the method may include dynamically adjusting an improvement in desired performance until performance saturation is achieved. In some embodiments, the desired performance may be generated using one or more of the plurality of inverse design approaches to ensure the performance improves in a user-selected objective, and the performance is better or the same in other objectives while satisfying all constraints on the system response. In some embodiments, the method may include outputting a set of solutions that dominates the selected reference solution.

In some embodiments, a non-transitory computer-readable storage medium may be provided, the comprising processor-executable instructions configured to cause a processor to perform an embodiment of the method as disclosed herein.

In some embodiments, a system may be provided. The system may include a non-transitory computer-readable storage medium and at least one processor (e.g., a “first” processor) operably coupled to it. The processor may be configured to execute processor-executable instructions stored on the non-transitory computer-readable storage medium to perform an embodiment of a method as disclosed herein. In some embodiments, the system may include one or more additional processors (e.g., a “second” processor). The additional processor(s) may be configured to receive instructions from a user, send the instructions to the first processor, and receive the one or more resulting solutions from the first processor. In some embodiments, the additional processor(s) may be further configured to reformat the one or more resulting solutions to a user-selected format (such as a graphical display, such as a circuit diagram), and display the user-selected format to the user. In some embodiments, the user-selected format may be defined by a selection of component values of a given circuit.

### BRIEF DESCRIPTION OF THE FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a flowchart of an embodiment of a disclosed method.

FIG. 2 is a flowchart of an embodiment of an optional initial phase of the disclosed method.

FIG. 3 is a flowchart of an embodiment of a phase of the disclosed method.

FIG. 4 is a schematic of a device.

FIG. 5 is a schematic of a system.

FIG. 6A is a graph showing non-dominated fronts (NDFs) obtained using NSGA-II and the seven inverse design methods for a cartpole optimization example. Dashed line shows the NDF of the union of all solutions obtained in an initial phase.

FIG. 6B is a graph showing a comparison of hypervolume using the eight methods in FIG. 6A.

FIGS. 7A and 7B are schematics showing an embodiment of inverse design using NN-Ver, including a training dataset for the surrogate model (7A) and generating candidate solutions using des_obj_ctr (7B).

FIGS. 8A and 8B are schematics showing an embodiment of inverse design using GMM, including a training the GMM with concatenated input and output data (8A) and generating candidate solutions using des_obj_ctr (8B).

FIG. 9 is a flowchart of an embodiment for fine-tuning results using the second phase.

FIGS. 10A-10C are graphs for a Lunar Lander optimization, showing NDFs obtained in the first phase (10A). A comparison of hypervolume using the eight methods in the first phase (10B), and results dominating the first phase solution (10C, top) and ASSENT (Terway, P, et al., “Fast design space exploration of nonlinear systems: Part II,” IEEE Transactions on Computer-Aided Design of Integrated Circuits and Systems, vol. 41, no. 9, pp. 2984-2999 (2022)) solution (10C, bottom). Dashed-line shows the combined NDF obtained using the different synthesis methodologies.

FIG. 11A is a schematic showing an example two-stage transimpedance amplifier topology, where the component values for devices within the rectangular box were to be optimized.

FIGS. 11B-11C are graphs for a two-stage transimpedance amplifier optimization, showing non-dominated solutions for bandwidth vs. power (11B) and a comparison of the hypervolume using the eight methods in the first phase (11C).

FIGS. 11D-11F are graphs showing results dominating the first phase solution (top) and ASSENT solution (bottom) shown in black for the two-stage transimpedance amplifier: area vs. power (11D), bandwidth vs. power (11E), and bandwidth vs. area (11F).

FIG. 12 is a table showing a comparison of INFORM designs that dominate conventional ASSENT and human design for a two-stage transimpedance amplifier. Parenthesis entries indicate the objective values when first obtaining a solution using INFORM that dominates the ASSENT or a human solution. Results shown for two different runs separated by a ‘/’. A hard constraint violation is encircled.

FIG. 13 is a schematic showing an example three-stage differential transimpedance amplifier topology.

FIGS. 14A-14G are graphs showing three-stage transimpedance amplifier optimization, including NDFs for power vs. bandwidth (14A), area vs. bandwidth (14B), area vs. power (14C), a comparison of hypervolume using the eight methods in the first phase (14D), results from the second phase dominating the first phase (14E-14G, top) and ASSENT solution (14E-14G, bottom) shown in black for a three-stage transimpedance amplifier for power vs. bandwidth (14E), area vs. bandwidth (14F), and area vs. power (14G).

FIG. 15 is a table showing a comparison of designs synthesized using INFORM (for two different runs separated by a ‘/’) with those synthesized using ASSENT and Wang (Wang, H, et al., “Learning to design circuits,” in NeurIPS Machine Learning for Systems Workshop, 2018) for a three-stage transimpedance amplifier (top part). The bottom part shows results for the case when the first solution, which dominates the ASSENT solution, obtained using GMM is driven to another solution.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Most existing system design methods use population-based optimization or a surrogate model for solving constrained multi-objective optimization. These methods are either sample-inefficient or consume significant amounts of time to generate candidate solution(s). They also cannot easily accommodate varying user-specified objectives and constraints on the system requirements. When designing a system with multiple objectives and constraints, the designer may first be interested in understanding the trade-offs among different objectives from a small number of simulations. In the next step, the designer may focus on specific regions of interest in the design space near a set of non-dominated solutions to further improve performance on the targeted objectives. This may help make the search process sample-efficient. The design methodology and tool disclosed herein addresses this challenge.

The disclosed approach provides a system and method to perform system optimization, and also improves the performance of existing systems.

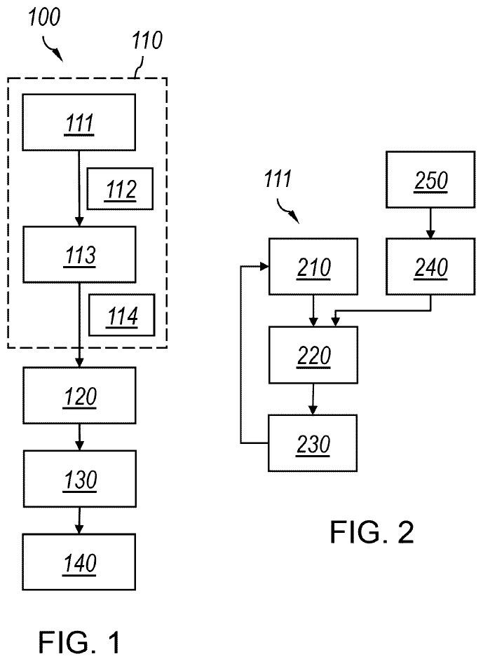

Referring to FIG. 1, in some embodiments, a method 100, such as a computer-implemented method, for performing optimization of a system may be provided. The disclosed methodology, sometimes referred to as INFORM, uses a two-phase approach 110 for sample-efficient constrained multi-objective optimization of real-world nonlinear systems.

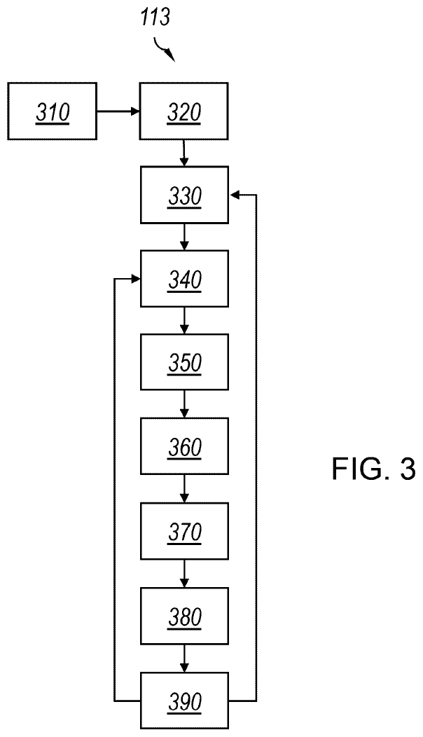

In the first (optional) phase 111, one modifies a genetic algorithm (GA) to make the design process sample-efficient. Referring to FIG. 2, in some embodiments, a generation of GA candidates is determined 210 according to known GA techniques, e.g., only via crossover and mutation. The candidates are then processed 220 by the GA model, and two or more candidates are output 230 as a result, typically the best performing candidates. In conventional GA techniques, a next generation of GA candidates would be determined based on the best performing candidates.

Here, however, the method may include injecting 240 one or more candidate solutions into the GA population, where inverse design methods were used to determine the injected solution instead of only crossover and mutation. In some embodiments, the candidate solutions include at least one solution determined via crossover and mutation, and at least one solution determined via an inverse design approach.

Injecting candidate solutions preferably does not occur during the first generation of candidate solutions fed through the GA models. Rather, candidate solutions may start to be injected when no improvement in extreme values of an objective function is determined for n consecutive generations within the GA, where n≥2. In some preferred embodiments, n=2.

Preferably, a plurality of inverse design approaches may be used (e.g., simultaneously/in parallel) to create 250 the candidate solutions for injection.

The inverse design approaches may include a neural network (NN), a NN verifier (NN-Ver), a Gaussian mixture model (GMM), and/or one or more combinations thereof. In some embodiments, only two approaches are used. In some embodiments, three approaches are used. Preferably, the plurality of inverse design approaches includes two or more single approaches (e.g., NN and GMM), and one or more combination approaches (e.g., NN+GMM). More preferably, the plurality of inverse design approaches includes three or more single approaches and, e.g., up to three combination approaches. Most preferably, the plurality of approaches used may include NN, NN-Ver, GMM, and all combinations thereof (i.e., NN+NN-Ver, NN+GMM, NN-Ver+GMM, and NN+NN-Ver+GMM).

A GMM assumes that the data probability distribution can be approximated by a finite number of Gaussian distributions. The probability density function (PDF) of a GMM with M components is denoted by p(x):

$$p ( x ) = {\sum }_{m = 1}^{M} {π}_{m} 𝒩 ( x ; {μ}_{m} , {Σ}_{m} ) \qquad ( 2 )$$

In Eq. (2), x represents the features, and πₘ, μₘ, and Σₘ denote the weight, mean, and variance of the m-th component, respectively. In scenarios where some of the features of an example are known, the unknown features can be estimated using the following equations:

$$p ( ) = {\sum }_{m = 1}^{M} {π}_{m} ( ; , ) \\ p ( {x}_{ℳ} \vert ) = {\sum }_{m = 1}^{M} ( ; , ) \\ = \frac{{π}_{m} ( ; , )}{p ( )} \\ = - \\ f ( ) = E \{ {x}_{ℳ} \vert \} = {\sum }_{m = 1}^{M} ( ) ( ) \qquad ( 3 )$$

In Eq. (3), the present and missing features of an example are denoted by [symbol] and [symbol] , respectively. [symbol] and [symbol] are computed by indexing μₘ corresponding to the locations of the present and missing features of the given example. [symbol] , [symbol] , and [symbol] are computed analogously by indexing on Σₘ. The PDFs of the present features and missing features conditioned on the present features are denoted by p( [symbol] ) and p( [symbol] | [symbol] ), respectively. The estimated value of the missing features, f( [symbol] ), is obtained from the expected value of the missing features conditioned on the present features. In the context of system design, [symbol] corresponds to the unknown component values and [symbol] corresponds to desired objectives/constraints.

An NN-Ver. determines whether there is an input corresponding to a given output of an NN. An example of this is NSVerify [see Akintunde M., et al., “Reachability analysis for neural agent-environment systems,” in Proc. Int. Conf. Principles of Knowledge Representation and Reasoning, 2018], a framework for verifying an NN with ReLU activation by representing the hidden neurons with constraints, as follows:

$${C}_{i} = \{ {\overline{x}}_{j}^{( i )} \geq {W}_{j}^{( i )} {\overline{x}}^{( i - 1 )} + {b}_{j}^{( i )} , {\overline{x}}_{j}^{( i )} \leq {W}_{j}^{( i )} {\overline{x}}^{( i - 1 )} + {b}_{j}^{( i )} + Q {\overline{δ}}_{j}^{( i )} , \\ {\overline{x}}_{j}^{( i )} \geq 0 , {\overline{x}}_{j}^{( i )} \leq Q ( 1 - {\overline{δ}}_{j}^{( i )} ) , j = 1 , … , {L}^{( i )} \} \qquad ( 4 )$$

In Eq. (4), ∀i, j, x̅ⱼ⁽ⁱ⁾ corresponds to the j-th neuron in the i-th layer, L⁽ⁱ⁾ is the number of neurons in the i-th layer, Wⱼ⁽ⁱ⁾ represents weights that determine the input to x̅ⱼ⁽ⁱ⁾, x̅⁽ⁱ⁻¹⁾ represents outputs from the (i−1)-th layer, bⱼ⁽ⁱ⁾ is the bias for neuron x̅ⱼ⁽ⁱ⁾, Q is larger than the largest possible magnitude of Wⱼ⁽ⁱ⁾x̅⁽ⁱ⁻¹⁾+bⱼ⁽ⁱ⁾, and δ̅ⱼ⁽ⁱ⁾ is defined as follows:

$${\overline{δ}}_{j}^{( i )} {=}^{△} \{ \begin{matrix}0 & if {\overline{x}}_{j}^{( i )} > 0 \\ 1 & otherwise\end{matrix} \qquad ( 5 )$$

The union of Cᵢ's in Eq. (4) represents the constraints imposed by the hidden neurons of the NN. CNMA and ASSENT techniques use the MILP formulation of an NN to synthesize systems with a single objective and multiple constraints. INFORM can handle CMOO problems and is, hence, more general.

Besides NN-Ver. and GMM, one can also use, e.g., an NN in INFORM. Rather than optimizing an objective function through gradient-based or gradient-free techniques, inverse design requires specifying the desired system performance. Inverse mapping enables a designer to drive the system to different performance metrics without having to start the optimization from scratch for each specification.

The NN-Verifier may convert an NN surrogate model with ReLU activation to a mixed-integer linear program (MILP). NN-based inverse design may use a surrogate model to map the simulation outputs (e.g., system objectives/constraints) to the simulation inputs (e.g., system component values). GMM may use the joint probability distribution of simulation inputs and corresponding simulation outputs to generate candidate solutions.

This first step may repeat, testing multiple generations of candidates. In some embodiments, the number of generations is no more than 10,000. In some embodiments, the number of generations is no more than 1,000. In some embodiments, the number of generations is no more than 100.

In some embodiments, the first step is repeated until at least one predetermined condition is met. In some embodiments, the first step may be terminated if no improvement in extreme values of an objective function is determined for n consecutive generations within the GA after a threshold generation, where n≥2 and the threshold generation ≥2. In some preferred embodiments, n=10 and the threshold generation is 10. In some embodiments, the value of the threshold generation equals the number n of consecutive generations (e.g., n=5 and threshold generation is 5). In some embodiments, the two values are different (e.g., n=10 and threshold generation is 5). In some embodiments, the first step may be terminated if the first step has been executing on one or more processors for more than a threshold period of time. In some embodiments, the threshold period of time may be 10 hours, 8 hours, 4 hours, 2 hours, or 1 hour. In some embodiments, the period of time may be based on the characteristic of the processor(s) executing the first step. For example, in some embodiments, the period of time may be based on the number of instructions per cycle that the processor executing the process can perform.

In some embodiments, the inverse design-based active learning may include generating a desired system response using Sobol and Latin Hypercube samples to gradually improve quality of resulting solutions, where the desired system response includes objective(s) and/or constraint(s).

In some embodiments, an inverse design approach of the plurality of inverse design approaches may include specifying a desired system response as outputs of the NN, and determining corresponding inputs after solving a mixed integer linear program formulation of the NN using the NN-Ver.

In some embodiments, an inverse design approach of the plurality of inverse design approaches may include a NN mapping a system response to system inputs, and wherein candidate solutions are generated by specifying a desired system response as inputs to the NN and determining corresponding NN output, where the system response includes an objective and/or constraint.

In some embodiments, an inverse design approach of the plurality of inverse design approaches may include, for, e.g., a GMM, considering the joint distribution of values of inputs and corresponding objectives and/or constraints, and wherein candidate solutions are generated by computing an expected value of an input given a desired system response.

In some embodiments, the method may include using a probability density function computed of the candidate solutions for the desired system response as a measure of confidence of the solution achieving the desired system response.

In some embodiments, the initial optional phase may be configured to achieve a higher hypervolume as compared to population-based optimization using a NSGA-II algorithm.

Referring to FIG. 1, at the end of the first phase, the output should be a set 112 of non-dominated solutions. Thus, the method may include obtaining a non-dominated set of solutions by injecting candidate solutions within a genetic algorithm (GA) using a plurality of inverse design approaches.

### Example 1 (First Optional Phase)

This example is an embodiment of the disclosed method, for use in designing an inverted cartpole. The goal is to minimize the time (t_{upright}) to make the pole upright and minimize the maximum cart displacement (max_{disp}) for a fixed iterative linear quadratic regulator. The component values that need to be determined are cart mass, pole length, and magnitude of force applied to the cart.

In the first step, a non-dominated set of solutions is obtained by injecting candidate solutions within GA using the following inverse design approaches: (1) NN-Ver, (2) GMM, (3) NN, and their combinations, resulting in seven inverse design methods. This example begins injecting individuals using the inverse design methodology upon observing no improvement in the extreme values of the objective function for two consecutive generations. In this example, the first phase is terminated when (1) no improvement in the extreme values of the objective function is observed for 10 generations after the tenth generation, or (2) the first phase has run for seven hours on an Intel Xeon processor with 64 GB of DRAM.

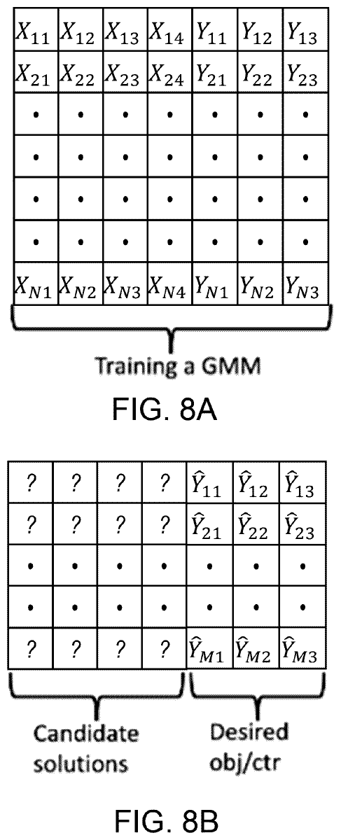

FIG. 6A shows, using black circles, the non-dominated front (NDF) obtained in the first phase using NSGA-II and the inverse design methods. The x-axis shows the time taken to make the cartpole upright and the y-axis shows the cart's displacement. Injecting candidate solutions using the inverse design method(s) in conjunction with GA yields better solutions than the solutions obtained using NSGA-II alone. FIG. 6B plots hypervolume vs. number of generations. Inverse designs obtained using NN-Ver.+GMM yield the highest hypervolume, indicating the benefits of injecting candidate solutions using inverse design methods.

More specifically, in the first phase (sometimes referred to as “Step 1”), the first generation of GA is initialized within the design search space of the component values. Then, these candidate solutions are evolved using a GA until saturation. After that, candidate solutions using inverse design methodologies are injected and included in the GA pool along with the candidate solutions generated using crossover and mutation. These solutions are evolved until termination criteria is met. Finally, the set of non-dominated solutions is returned.

Algorithm 1 describes Step 1 in detail. The first GA generation is initialized with P candidate solutions using Latin hypercube sampling (LHS) based on points within the design space comp_range of component values. The initial phase of Step 1 is the same as that in NSGA-II. Note that any CMOO exploration tool like NSGA-III could also be used instead of NSGA-II. All individuals are simulated in the generation to compute the corresponding system response.

The simulation inputs and the corresponding outputs are stored in a buffer B. The buffer is used as a lookup table when repeating a simulation to minimize the total number of simulations. NSGA-II is used to rank the individuals in a generation. Next, tournament selection is used to create a mating pool of size P. Crossover and mutation are then used with a probability of cross and mut, respectively, to create P children. NSGA-II is used to select P individuals from the 2P individuals for the next generation. If the evolution saturates (indicated by the switchGA flag), the process then begins injecting candidate solutions using one of the seven inverse design methods invDesignMethod. The switchGA flag is set to True when the extreme values of the objective function do not change for a few generations. Using extreme values helps discover the approximate range for each objective value. The surrogate models used for inverse designs are trained after each generation using past simulations. numInvDesign candidate solutions are generated using invDesignMethod and are added to the P candidate solutions generated using GA. At each iteration, numInvDesign is selected randomly. Random selection helps generate more diverse individuals, thus avoiding or delaying performance saturation. Only feasible solutions of the MILP are retained when using an NN-Ver. for inverse design. All the candidate solutions generated using the inverse design method and some candidate solutions generated using crossover and mutation are used to obtain P candidate solutions for the next generation. Step 1 is terminated when the stopping criteria stop is met.

Algorithm 1/Step 1: Discovering non-dominated solutions

Input: P: population size; comp_range: range of each input component; stop: stopping
criteria; switchGA: switching criterion for GA+inverse design; B: buffer to store
simulations; mut: mutation probability; cross: crossover probability; invDesignMethod:
inverse design choice(s): (1) NN-Ver., (2) GMM, (3) NN, (4) NN-Ver.+GMM, (5) NN-
Ver.+NN, (6) NN+GMM, (7) NN-Ver.+NN+GMM; numInvDesign: #inverse designs
injected per generation.
Initialize 1^{st} generation with P LHS solutions within comp_range
while not stop do
Compute objectives for all P
Store simulation inputs/outputs in B
Rank P using NSGA-II
Use tournament selection to create mating population of size P
Use reproduction based on crossover and mutation to create P children
if switchGA then
Update the surrogate used in invDesignMethod
- Generate numInvDesign using invDesignMethod
- Append numInvDesign candidate solutions to the ones generated using crossover and
mutation
- Discard some candidate solutions generated using crossover and mutation to retain only P
candidate solutions
end if
Select P from 2P members using NSGA-II
end while
Output: All non-dominated solutions and buffer B

Algorithm 2 shows the procedure for generating desired objectives/constraints around design D. In CMOO problems, D depicts solutions that meet the constraints and attain the top ranks as determined by NSGA-II. If none (or fewer than the cardinality of D) of the solutions satisfy the constraints, the solutions with minimum constraint violation computed using Eq. (6) may be used.

$${\sum }_{i} \frac{\vert {obs}_{i} - {con}_{i} \vert}{{con}_{i}} {\{ {obs}_{i} \neq {con}_{i} \}}_{} \qquad ( 6 )$$

where conᵢ is the i-th constraint, obsᵢ is the observed value for the i-th constraint, and [symbol] ^{{obsi≠coni}} is an indicator function that takes the value 1 in case of conᵢ violation (note that obsᵢ can be greater or less than coni) and 0 otherwise. The percentage improvement fr to be targeted in the objective values around the solution in D is determined by generating a random number (fr) in the [lb_per,ub_per] range. Small values of fr lead to exploitation near the best solution. Higher values lead to exploration. N desired objectives/constraints (des_obj_ctr) were generated per solution from D. At each successive call to Algorithm 2, the method alternated between Sobol and LHS point_type to generate des_obj_ctr around the candidate in D. Sobol samples are distributed uniformly over a unit hypercube. Alternating between Sobol sampling and LHS to generate des_obj_ctr and using a random value for fr helps avoid performance saturation. des_obj_ctr are clipped to satisfy all constraints (des_obj_ctr_clp). The content of des_obj_ctr_clp is stored in the des_obj_ctr_list list.

Algorithm 2 Generation of desired objectives/constraints

Input: D: solutions around which desired objectives/constraints des_obj_ctr are generated;
lb_per, ub_per: lower and upper bound percent for generating des_obj_ctr; N: number of
des_obj_ctr per design from D; point_type: LHS or Sobol samples.
fr = random number in the [lb_per,ub_per] range
des_obj_ctr_list = [ ]
for candidate in D do
des_obj_ctr = Generate N point_type samples within fr around candidate solution
des_obj_ctr_clp = clip des_obj_ctr to satisfy the constraints
Append des_obj_ctr_clp to des_obj_ctr_list
end for
Output: des obj ctr list

Algorithm 3 shows NN-Ver-based inverse design. The top solutions (top_sols) from buffer B are selected to train the NN surrogate model. All (mim_train) the solutions that meet the constraints are selected to train the surrogate model. If the number of solutions that meet the constraints is large, mum_train is clipped to lie in [/b_train, ub_train]. Component values and the corresponding desired objectives/constraints are scaled to [0,1]. The best NN architecture (best_arch) is selected from the NN_archs choices for different NN architectures. Eq. (4) is then used to convert best_arch into its corresponding MILP using the desired objectives and constraints from des_obj_ctr_list generated using Algorithm 2. Since the method will have a different MILP for each desired des_obj_ctr, multiple cores may be used to solve the MILP. Finally, the method returns can_sols NN, which is the list of all feasible solutions obtained by solving the MILP.

Algorithm 3 NN-Verifier-based inverse design

Input: des_obj_ctr_list : list of desired objectives and constraints; B: stored buffer with
simulation inputs and outputs; lb_train, ub_train: lower and upper bound on the number of
solutions to train the surrogate model; NN_archs: search space of NN architectures;
comp_range: range of each input component.
num_train = random number in [lb_train,ub_train]
num_train = min(num_train, buffer size B)
top_sols = select the best num_train solutions from B
best_arch = best NN architecture among NN_archs trained on top_sols
can_sols_NN = [ ]
for des_obj_ctr in des_obj_ctr_list do
Use Eq. (4) to convert best_arch into corresponding MILP
Set output constraint of the MILP to des_obj_ctr and input constraint to comp_range
sol_milp = MILP solution to determine the inputs
if sol_milp is feasible then
append sol_milp to can_sols_NN
end if
end for
Output: can sols NN

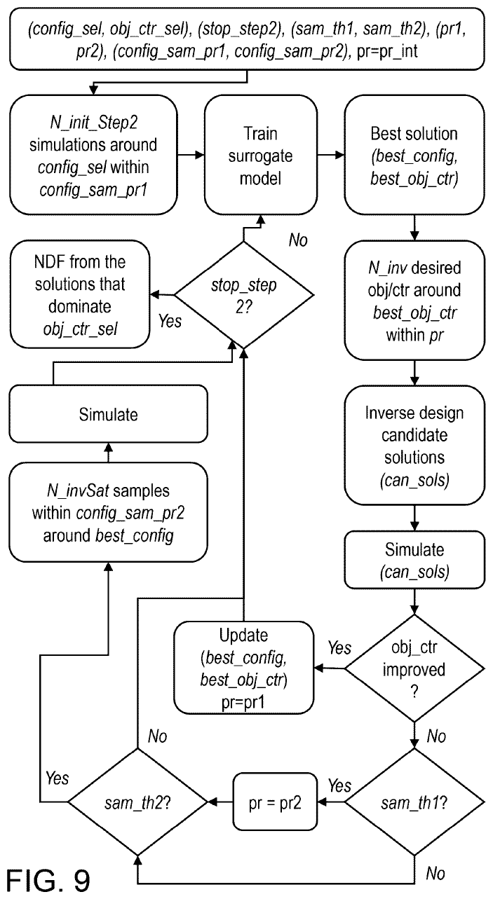

FIG. 7A shows the data used to train the NN surrogate model for NN-Ver-based inverse design. The illustration assumes that each design has four components, three objectives/constraints, and num_train=N. Each row represents a training example. Xᵢⱼ represents the j-th component of the i-th training instance. Similarly, Yᵢⱼ represents the j-th objective/constraint of the i-th training instance. FIG. 7B depicts des_obj_ctr using Ŷᵢⱼ, where i is the output number and j is the j-th component of the i-th des_obj_ctr. The unknown value of the components for each des_obj_ctr is depicted by a ‘?’. M candidate solutions are generated using Algorithm 2.

Algorithm 4 shows GMM-based inverse design. The training setup is similar to that in Algorithm 3. The training dataset X_Y is created for GMM by concatenating the simulation inputs (i.e., component values) and its corresponding outputs (objectives/constraints). The best_gmm (best_gmm) are determined from mix space by varying the number of mixtures used for training. The GMM with the lowest Akaike information criterion (AIC) score is used. f(xₚ) from Eq. (3) is used to determine the candidate solutions for each des_obj_ctr from des_obj_ctr_list. The solutions are clipped to lie within the range of each component (com range). The method returns the list of all the candidate solutions denoted by can_sols_gmm.

$$p ( ) = {\sum }_{m = 1}^{M} {π}_{m} ( ; ) \\ p ( \vert ) = {\sum }_{m = 1}^{M} ( ; ) \\ = \frac{{π}_{m} ( ; )}{p ( )} \\ {μ}_{m , ℳ \vert 𝒫} = ( - ) \\ = - \\ f ( ) = E \{ \vert \} = {\sum }_{m = 1}^{M} \qquad ( 3 )$$

Algorithm 4 GMM-based inverse design

Input: des_obj_ctr list : list of desired objectives and constraints; B: stored buffer of
simulation inputs and outputs; lb_train, ub_train: lower and upper bound on the number of
samples to train the surrogate model; mix space: search space for number of mixtures to
train the GMM; comp_range: range of each input component.
num_train = random number in [lb_train,ub_train]
num_train = min(num_train, buffer size B)
top_sols = select the best num_train solutions from B
X Y = [X;Y], concatenate input and output columns of top_sols
best_gmm = best GMM from the mix space trained on XY
can_sols_gmm = [ ]
for des_obj_ctr in des_obj_ctr_list do
sol_gmm = use Eq. (3) to determine the expected value of the unknown input component
f(xₚ) after setting the objective and constraint (xₚ) to des_obj_ctr sol_gmm _clip = clip
sol_gmm to lie within comp_range
append sol_gmm _clip to can_sols_gmm
end for
Output: can sols gmm

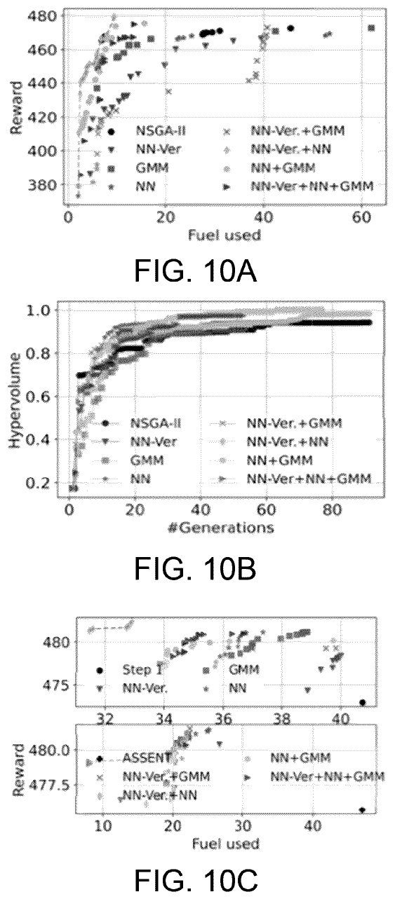

FIG. 8A illustrates how training is done with the GMM. In contrast to an NN-Ver-based inverse design that treats the input components and corresponding objectives/constraints separately, the two are concatenated using past simulations to train the GMM. FIG. 8B shows how candidate solutions are generated. The expected value of the conditional distribution of the input is used, given des_obj_ctr, to determine the unknown component values shown by ‘?’.

Finally, NN-based inverse design can be described. NN architectures used in NN-Ver. can be inverted to determine the search space of the NNs. For example, if one uses NN with [(40,20,8)] neurons in the hidden layers when using NN-Ver-based inverse design, that architecture can be replaced with [(8,20,40)]. The inverted architecture maps the simulation outputs to the corresponding inputs. num_train data instances are used to determine the best NN architecture and the NN is used to predict the component values for each des_obj_ctr. Like GMM-based inverse design, the candidate solutions are clipped to lie within the range of each component (comp_range). The method then returns the list of all the candidate solutions.

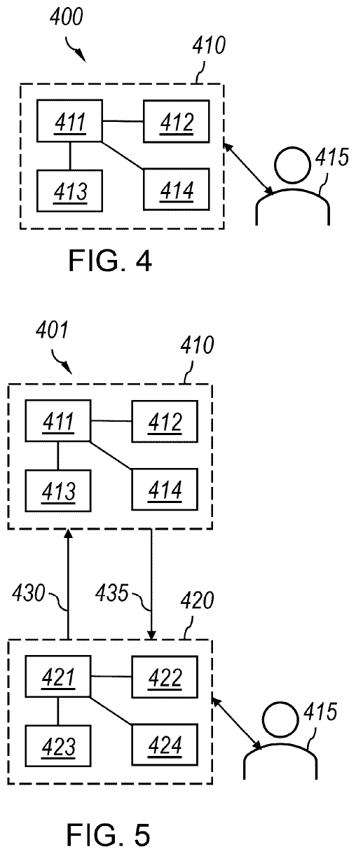

Referring back to FIG. 1, in the second phase 113 (sometimes referred to as “Step 2”), the method uses the inverse design method to improve the solution (e.g., the objective function values) from the first phase. Referring to FIG. 3, in some embodiments, the second phase may include selecting 310 one or more of the solutions from the set 112 of non-dominated solutions. In some embodiments, the solution(s) may be selected by a user. In some embodiments, the solution(s) may be automatically selected by a processor executing the method. For example, in some embodiments, each solution could be given a weighted score based on performance of specific predetermined objectives, and the highest scoring solution(s) could be selected automatically. The selected reference solution will include an input and a corresponding output (e.g., a “pair”). The second phase will involve iterations intending to improve on the selected reference solution. Thus, for at least the first iteration, the selected reference solution may be considered or identified as a current best observed solution.

The second phase may include determining or receiving a selection 320 of one or more objectives and/or constraints of the selected reference solution to be improved. In some embodiments, this may include displaying options for a user to select (e.g., based on the selected reference solution). In some embodiments, this may include a user-defined objective (e.g., an objective that must be minimized or maximized, based on characteristics of the solution(s)).

The second phase may include generating and simulating 330 multiple inputs within the neighborhood (e.g., within a first predetermined fraction (“fr_in”) of the current best observed solution. In some embodiments, the first predetermined fraction may be a default value. In some embodiments, the first predetermined fraction may be a value selected by a user.

The second phase may include training 340 one or more surrogate models using previously determined inputs and system responses. In some embodiments, these are inputs and system responses previously determined in the computer-implemented method (e.g., inputs and system responses from the initial optional phase, or in previous iterations of the second phase). In some embodiments, these may include inputs and system responses provided by a user prior to the start of the second phase. In some embodiments, at least one iteration of this step only includes inputs and system responses previously determined in the computer-implemented method. In some embodiments, every iteration of this step only includes one or more inputs and system responses previously determined in the computer-implemented method.

In some embodiments, a predefined number of solutions (e.g., Input and Output pairs) from the optional initial phase that are closest to the selected solution(s) may be used to train the surrogate models. For example, simulation inputs (i.e., component values) and corresponding outputs (i.e., objectives and/or constraints) may be used to train a surrogate model used for inverse design.

The second phase may include generating 350 a plurality of desired system responses within a second predetermined fraction (“fr”) around the current best observed solution. In some embodiments, each desired system response improves the objective that was determined or selected in the second step (determining or receiving a selection 320). In some embodiments, each desired system response satisfies any specified constraints on the system response. Such constraints may be introduced by a user at any time in this method. For example, in some embodiments, any constraints may be provided before generating and simulating 330 multiple inputs. In some embodiments, the requirement may include at least one of the objectives of the selected reference solution to be improved.

The second phase may include generating 360, using one or more of the plurality of inverse design approaches (e.g., from the initial optional phase) to generate candidate solutions at the desired system response generated in step 350.

The second phase may include simulating 370 the candidate solutions to provide one or more resulting solutions. Candidate solutions may be generated and simulated as disclosed herein for the initial optional phase.

The second phase may include updating 380 the current best observed solution. This may be based on a determination of whether any resulting solution improves the selected objective to be improved.

The second phase may repeat several steps until it is determined 390 that certain criteria are met.

In some embodiments, the criteria may include a determination of whether the current best observed solution has improved in m iterations, and if not, reducing the value of the second predetermined fraction (“fr”) prior to repeating steps 340-380. In some embodiments, 2≤m≤20. In some embodiments, 3≤m≤10. In some embodiments, 4≤m≤8. In some embodiments, m=5.

In some embodiments, the criteria may include a determination of whether the current best observed solution has improved in k iterations (k>m, if m is used), and if not, adjusting the value of first predetermined fraction (“fr_in”) and repeating steps 330-380. In some embodiments, the value of the first predetermined fraction is reduced. In some embodiments, 5≤k≤50. In some embodiments, 5≤k≤20. In some embodiments, 7≤k≤15. In some embodiments, k=10.

In some embodiments, the criteria may include a determination of whether the current best observed solution has not improved in a predetermined period (t) of time or has not improved for in a predetermined number (i) of iterations (where i>k and m, if k and/or m are used), and if no improvement has been seen, stopping the repeating of steps. In some embodiments, t≤12 hours. In some embodiments, t≤8 hours. In some embodiments, 10 minutes ≤t≤12 hours. In some embodiments, 2 hours ≤t≤10 hours. In some embodiments, t=4 hours, 6 hours, or 8 hours. In some embodiments, i≤500 iterations. In some embodiments, i≤250 iterations. In some embodiments, 10≤i≤1000 iterations. In some embodiments, 20≤i≤500 iterations. In some embodiments, 20≤i≤100 iterations. In some embodiments, 20≤i≤50 iterations.

### Example 2 (Second Phase)

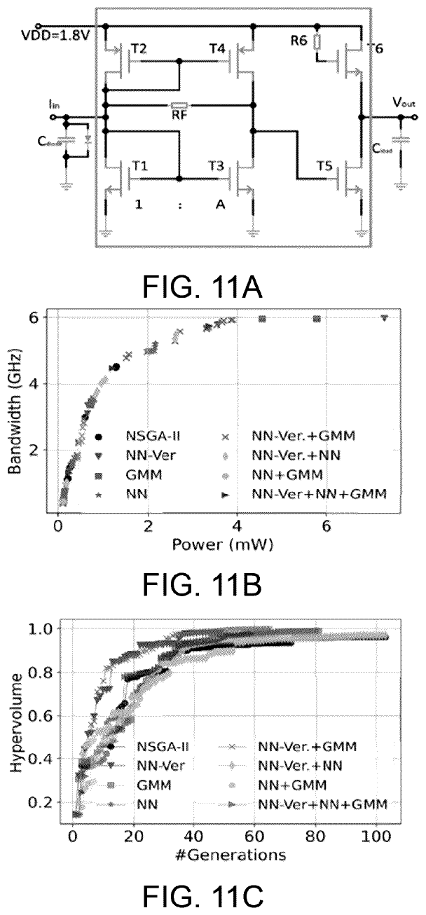

In the second phase, the inverse design method is used to fine-tune/improve the solution it receives at the beginning (e.g., from the first optional phase). FIG. 9 shows an example fine-tuning procedure. The method includes generating and simulating N_init_Step2 LHS samples within config_sam_pr1% around the component values (config_sel) corresponding to the solution chosen for fine-tuning in this phase. Note that in the case of some costly simulations, an alternative approach may be to use some logged simulations from the buffer (B) in the first optional phase (here, the first example disclosed to pre-train the surrogate model used for inverse design, as illustrated in another example). The simulation inputs (i.e., component values) and corresponding outputs (i.e., objectives/constraints) were used to train the surrogate model used for inverse design. Algorithm 2 was used to generate N_inv_des_obj_ctr with the aim of improving the value of the objective function by up to pr %. Candidate solutions (can_sols) were generated using the same inverse design methods as in the first example disclosed herein. One can then simulate can_sols and update the component values (best config) corresponding to the best objective value (best_obj_ctr) on observing a better solution. In this example, pr1 is used as the improvement percentage whenever an improvement in the value of the objective function is observed. If the example does not observe an improvement after sam_th1 iterations of the above steps, the improvement percent is lowered for des_obj_ctr to pr2. If no improvement is observed even after sam_th2 iterations, the method generates and simulates N_invSat LHS samples within ±config_sam_pr2% of best config. The method then repeats this process until it meets the stopping criteria (stop_step2) for this phase. Finally, in this example, the NDF of the solutions that dominate the reference solution chosen (e.g., a solution from the first phase chosen to be optimized) are returned.

Referring to FIG. 1, in some embodiments, the method may include identifying 120 a chosen solution from the one or more resulting solutions. This may be done by a user, or may be done by the processor performing the method, as disclosed herein.

In some embodiments, the method may include outputting 130 a proposed solution. In some embodiments, this may include outputting a chosen solution in a format appropriate for implementing the chosen solution. In some embodiments, this may include displaying the solution to, e.g., a user. In some embodiments, the method may include implementing 140 the proposed solution.

Various system may be optimized; non-limiting examples of such systems to be optimized include systems that utilize one or more electric circuits, such as those used in or in combination with an automotive vehicle, a microchip or integrated circuit, or a component in an electrical grid.

In some embodiments, the system being optimized may have a fixed architecture. That is, in some embodiments, the architecture of the system used to generate solutions is the same as the architecture of the system being optimized. For example, in some embodiments, the physical, chemical, and/or electrical properties of the components in the system may be optimized, but how the different components of the system are connected does not.

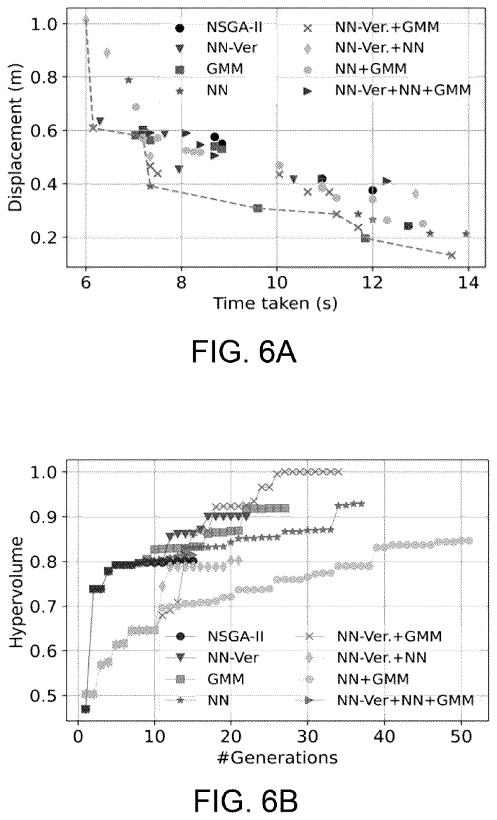

Referring to FIG. 4, in some embodiments, a device 400 may be provided. The system may include a first device 410 that may include one or more processors 411 operably coupled to a memory 412, a non-transitory computer-readable storage medium 413, and one or more I/O components 414, such as a mouse, keyboard, display, etc. In some embodiments, the device may be used to transfer information to/from a user 415. The non-transitory computer-readable storage medium may contain instructions that, when executed by the processor, cause the processor to perform the method as disclosed herein.

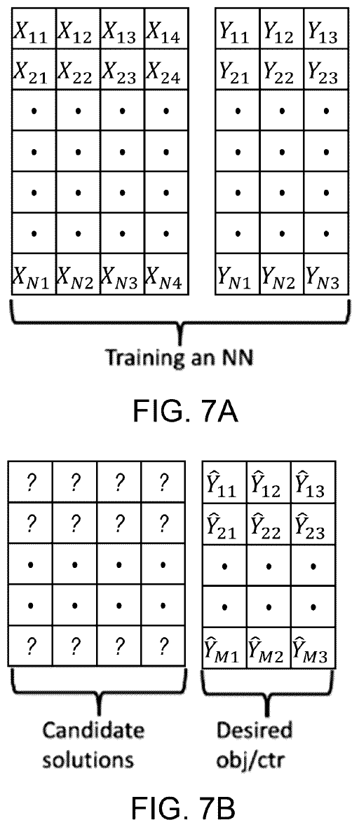

Referring to FIG. 5, in some embodiments, a system 500 may be provided. The system may include a first device 410 as described with respect to FIG. 4. The system may also include at least one second device 420 that may include an additional processor 421 operably coupled to a memory 422, a non-transitory computer-readable storage medium 423, and one or more I/O components 424, such as a mouse, keyboard, display, etc. In some embodiments, the second device may be used to transfer information to/from a user 415. To perform the method as disclosed herein, the first device may be configured to receive 430 information from the second device to the first device and send 435 information to the second device.

In some embodiments, the additional processor(s) may be configured to receive instructions from a user, send the instructions to the first processor, and receive one or more solutions from the processor in the first device. In some embodiments, the additional processor(s) may be further configured to reformat the one or more solutions to a user-selected format (such as a graphical display, such as a circuit diagram), and display the user-selected format to the user.

In some embodiments, the first device may be configured to receive the instructions from the additional processor(s), perform the method as disclosed herein, and transmit the solutions to the second device.

The disclosed approach can be employed in varied industries including automotive, circuit design, aerospace, and power, and can be extended to generate synthetic data that can help in machine learning tasks in small-data regimes. In some embodiments, the system being optimized is an electric circuit. In some embodiments, the system being optimized is a consumer packaged good or a component of a consumer packaged good. In some embodiments, the system being optimized is a vehicle or a component of a vehicle. In some embodiments, the system being optimized is a piece of manufacturing equipment.

The disclosed approach may be employed, inter alia, in the following industries:

Automotive industry: Most OEMs and their suppliers need to run multiple experiments and spend significant resources to optimize system performance. The systems have multiple objectives and constraints. As the method disclosed herein is system-agonistic, one can tackle a wide array of systems. The disclosed method is sample-efficient, thus reducing the cost to run experiments. One can also take an existing system and improve its objectives further. Consider a Tier 1 automotive supplier manufacturing electric power steering that utilizes a motor to provide steering assistance. The objectives are to maximize the torque, minimize the torque ripple and the inherent harmonics, and limit the maximum battery current. Torque ripple is directly associated with Noise, Vibration, and Harshness that impacts the steer feel. One can use the disclosed method (INFORM) to optimize all objectives and meet the constraints. If the customer has a simulator, one can directly use it to generate candidate solutions for optimization. In the absence of the simulator, one could use the end-of-line test data to learn a surrogate model. One can then use the disclosed method to suggest the next set of candidate solutions. The disclosed method also helps reduce the time spent on test tracks by presenting an automatic tuning interface, thus significantly reducing design cost.

Chip/IC design: As disclosed herein, one can automatically determine the values of different components to yield designs with the best objectives. One can even take an existing circuit and improve its performance using the disclosed methodology without using the optional first phase. One can incorporate the disclosed package into other commercial tools offered by, e.g., Cadence and/or Synopsys to reduce synthesis time of electric circuits. The previous approach uses a grid search technique that is extremely slow due to the combinatorial optimization nature of the problem. One can generate candidate solutions using inverse design and active learning to automate the optimization procedure, thus significantly reducing the design time and cost.

Power industry: Many grid operators need to determine the optimal system configuration to optimize the operational cost and performance of the electric grid. They also need to meet constraints to ensure that the grid operates in the stable region. One can use the disclosed method to determine the optimal system configuration.

Use of inverse designs enables the disclosed method to directly handle multiple objectives and constraints on simulation inputs and outputs instead of using a pseudometric like entropy or expected hypervolume improvement (EHVI). The computational complexity of obtaining the hypervolume increases with an increase in the number of objectives. Thus, in some embodiments, the method may be free of any computation or determination of a pseudometric.

At least in part because of the extremely parallel nature of most modern GPUs as compared to modern CPUs, most modern design optimization methods utilize GPUs to some extent to take advantage of modern GPU architectures. However, the disclosed sample-efficient and lightweight design methodology does not require graphical processing units (GPUs), thus reducing the optimization cost.

Additionally, many current methods require tweaking hyperparameters to allow a given approach to work for multiple different specific use cases/experiments, which increases the design cost. However, it has been illustrated that, for the disclosed methodology, the same setup works for multiple experiments without tweaking hyperparameters. The robustness of the disclosed method is also illustrated by repeating the optimization using the seven inverse design methods. Different repeats yield similar results.

Most existing methods treat the distribution of components values and the corresponding objectives/constraints separately, however, in some embodiments, the disclosed inverse design based on the Gaussian mixture model (GMM) considers the joint distribution of the values of the components and the corresponding objectives/constraints.

GMM provides a distribution over the design space and the objectives/constraints instead of just a point estimate as in a neural network, thus providing a new dimension to inverse design. The distribution makes the estimate of the component values robust to uncertainty.

Current methods in the industry require significant human effort to tune the system configuration for the best performance. Therefore, the process relies on human expertise. In the automotive industry, the experiments are sometimes carried out on a test track or in a physical laboratory, thus increasing the design cost. The disclosed method produces the most promising candidate solution using the past behavior of the system, thus making the process autonomous. In addition, past system behavior may be incorporated in the disclosed model, thus reducing the human expertise needed to design a system.

Further, the disclosed method can enhance an existing solution, which can be chosen by the designer. Most current methods need to start the multi-objective optimization procedure from scratch for a different specification. The disclosed approach employs the inverse design methods disclosed herein to make the search sample-efficient by performing targeted simulations, thus reducing the cost to run the experiments.

While INFORM may be limited to optimization of a fixed system architecture, recent techniques use transfer learning across different electrical circuit topologies and a weighted sum of different outputs during optimization, and INFORM can be extended similarly by using simulation data from one system architecture to optimize another system architecture to solve the optimization problem.

Experiments have been conducted on multiple benchmarks, e.g., lunar lander, unmanned underwater vehicle, and the design of transimpedance amplifiers. Results show an improvement in objective values of up to 33% and a reduction in the optimization time by up to 29× compared to a state-of-the-art baseline methodology.

The presently disclosed approach also allows for handling multiple objectives/constraints simultaneously as opposed to a weighted sum of objectives and constraints.

One can reduce design time by automating the procedure for synthesizing electronic chips. By using inverse designs as disclosed herein, one can augment human capabilities and reduce design cost. One can take an existing design and improve its performance. The disclosed method presents a flexible approach to improving the performance of an existing system or starting the optimization from scratch. As an example, the disclosed approach may be employed to optimize systems used in deep/hard technologies.

One can easily trade off the cost of simulation and the time required for optimization by adjusting the number of candidate solutions generated at each iteration.

Most existing methods rely on population-based optimization to solve multi-objective optimization problems. Employing the disclosed approach, one can discover a set of non-dominated solutions in the initial optional phase instead of discovering the entire set of solutions. One can then focus only on the solutions of interest to the designer, thus making the design process sample-efficient.

### Example 3 (Lunar Lander)

In this example, a Lunar Lander benchmark from OpenAI/Gym (see www.gymlibrary.dev) is used with the same setup as used in literature (see Narain, S., et al., “Fast design space exploration of nonlinear systems: Part I,” IEEE Transactions on Computer-Aided Design of Integrated Circuits and Systems, vol. 41, no. 9, pp. 2970-2983 (2022)), the contents of each of which are incorporated herein by reference in its entirety.

The goal is to design the controller, determine the module's initial position, and optimize for two objectives subject to two constraints. The two objectives are: (1) maximize the reward, and (2) minimize the fuel used. The two constraints are (1) the time taken to land≤10 units, and (2) the mission must be successful. The following objectives were used in GA:
Fuel used in the mission.
Time taken to land. If the time is less than or equal to 10 units, this objective value was set to 0 as the only need was to satisfy the time constraint.
Flag indicating whether a mission is successful. When solving a minimization problem with GA, one can flip the flag to take the value of 0 for success and 1 otherwise.
Reward achieved in the mission. Here, the example negated the reward sign and converted it into a minimization problem.

In the event of a failed mission, the fuel, time, and reward objectives were set to a large number to indicate failure.

In this example, the first phase was run for about seven hours (allowing the last generation to complete even if it exceeds the allotted time slightly) or until performance saturation. Lunar lander simulations are fast. Hence, the saturation criterion generally leads to the termination of the first phase. In this example, candidates began being injected into GA using inverse designs if the extreme values of the objectives did not improve for two consecutive generations after the second generation. Saturation was assumed if the extreme value of the objective function remains unchanged for ten generations after the tenth generation. This saturation criterion worked well for all examples disclosed herein.

In this example, the method used a tournament size of 10, a mutation rate of 0.1, and a crossover probability of 0.9 for the GA. The first phase was run using NSGA-II alone, and NSGA-II with injections using the seven inverse design methods. When using NN-Ver, an NN was selected with one of the following architectures (NN_archs): [(40,20,8), (30), (15), (100), (50), (200), (20,20,8), (300), (400), (500), (600)], where the tuples represent the number of neurons in the hidden layer(s). When using NN, the NN architectures choices from that used in NN-Ver. were inverted: [(8,20,40), (30), (15), (100), (50), (200), (8,20,20), (300), (400), (500), (600)]. GMM and a Multi-Layer Perceptron Regressor from the Scikit-learn package, an initial learning rate of 0.0001, adaptive learning, and a maximum iteration count of 100,000 were used to train the NN. Other parameters were set to their default values. When using GMM, #mixtures in the [1,min (200,length (train))] range were varied in steps of 2. Here, length (train) denotes the number of training data instances. The maximum number of mixtures were limited, and alternate component choices were skipped to speed up training. The choice of the surrogate model (GMM and NN) was updated after each generation. num_train training instances were randomly selected in the [1000,2000] range to train the surrogate model. When using only GMM, NN-Ver. or NN, inverse design candidates in the α=[10,96] range were randomly injected. When using NN-Ver.+GMM, NN-Ver.+NN, or NN+GMM, α=[10,48] was used, and when using NN-Ver.+NN+GMM, α=[10,32] was set for each inverse design method. Top candidates in the D=[2,2] range were randomly selected, where λ=min (α/2, 10). The same number of candidates (N=α/D)) were injected around each selected candidate. The percentage improvement required (fr) from the [1,10] % range was randomly selected. des_obj_ctr was clipped in case of a constraint violation. For example, if des_obj_ctr is [8,11,1,400], it was changed to [8, 10,1,400] to meet the constraint on the time taken. The items included in des_obj_ctr are fuel used, time taken, success, and reward, respectively.

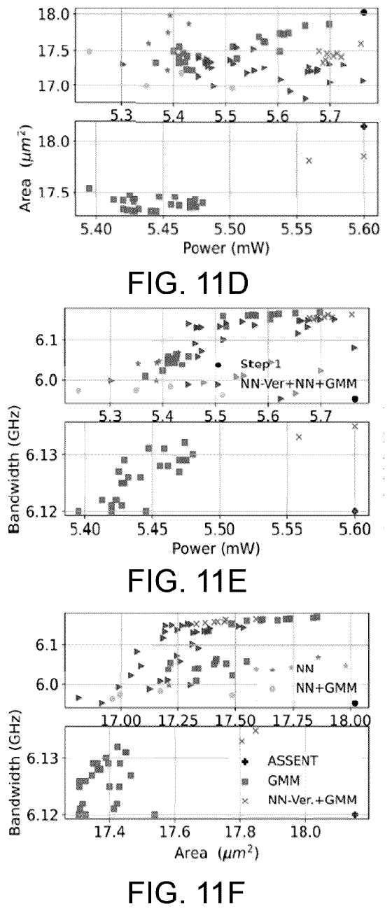

FIG. 10A shows the first phase NDF for the eight cases. It is noticed that using GA in conjunction with inverse design yields better performance. The improvement in performance were attributed to targeted candidate solutions generated using inverse designs. FIG. 10B plots hypervolume vs. #generations. The two objectives were scaled to lie within [0,1] and (1.1, 1.1) was used as the reference point. Hypervolume computation may be done using the setup given in the PyMOO documentation. The hypervolume is normalized to the maximum hypervolume obtained across the eight methods. It was observed that injecting solutions based on inverse designs in conjunction with GA yields better hypervolume in comparison to NSGA-II alone, with NN-Ver.+NN having the highest hypervolume. For a fair comparison, NSGA-II was run until the maximum #generations attained with injections among the seven inverse designs methods (NN+GMM in this case). The number of simulations and time (sim.+algorithm) needed for each synthesis methodology are as follows: (1) GA: 8,132 sim, 293+90s; (2)NN-Ver: 3,608 sim, 682+6,172s; (3) GMM: 4,887 sim, 180+586s; (4) NN: 2,631 sim, 99+30,600s; (5)NN-Ver.+GMM: 4,543 sim, 409+6,648s; (6)NN-Ver.+NN: 7,439 sim, 962+13,899s; (7) NN+GMM: 7,829 sim, 294+10,545s; (8)NN-Ver.+NN+GMM: 4,724 sim, 494+7,158s. GA takes the least time as crossover and mutation are fast operations. Solving MILP makes NN-Ver-based inverse design slow. Training the GMM surrogate and solving Eq. (2) is a relatively fast operation.

In the second phase, the example includes improving a solution from the NDF corresponding to the highest reward obtained with NN-Ver.+GMM injections in the first phase. When generating des_obj_ctr, the example tries to improve the value of the reward and set the fuel used corresponding to the selected solution as a constraint. Note that this example only applies the fuel constraint when des_obj_ctr (generated by sampling within pr % of the selected solution) exceeds the fuel consumed by the first phase solution. The other constraints are kept the same as in the first phase. The seven inverse design techniques are used to obtain solutions that dominate the selected first phase solution. The same search space is used for the surrogate models, that is, NN architecture choices and number of GMM mixtures used in the first phase. As the lunar lander simulations are fast, this example only uses the simulations that meet all the constraints to train the surrogate model.

We first generate N_init_Step2=100 candidate solutions using LHS within config_sam_pr1%=±10% of the component values of the configuration (config_sel) selected from the first phase. These simulation inputs and the corresponding outputs are used to train the surrogate model. The second phase is stopped (stop_step2) if: (1) there is no improvement in the value of the objective function (reward in this case) for 25 iterations, or (2) the second phase has run for 7 hours. The (best config, best_obj_ctr) corresponds to the solution with the highest reward and a fuel consumption that is at least as good as the solution chosen in the first phase. Here, best config refers to the component values of the configuration that yields the best value of the objective function. In each iteration of the second phase, candidate solutions are randomly generated in the N_inv=[10,50] range for each inverse design technique. In the first iteration of the second phase, pr=pr_init is set to (5,10) %. The example changes pr=pr1 to (1,5) % if it does not observe an improvement in the value of the objective function, and further changes pr=pr2 to (1,2) % if it does not observe an improvement for sam_th1=5 iterations of the second phase. Upon observing an improvement, the example resets pr=pr1 to (1,5) %. If the example does not observe an improvement for sam_th2=10 iterations, it generates N_invSat=100 LHS samples within config_sam_pr2%=1% of the best system configuration (best config). A lower value of pr helps in exploitation, while a higher value helps in exploration to rapidly improve the value of the objective function. Unless otherwise specified, the example uses the same setup for the first and second phases in all experiments.

The top row of FIG. 10C shows the solution selected from the first phase (“Step 1”). The example obtains solutions that dominate the selected solutions using all inverse design techniques. It is observed that the highest reward (482.4) is obtained using NN-Ver.+NN-based inverse design. The time and number of simulations required in the second phase corresponding to the selected solution from the first phase are (1)NN-Ver: 5,689 sim, 9.3+276.3 min; (2) GMM: 12,767 sim, 5.5+415.9 min; (3) NN: 6,132 sim, 2.9+350.9 min; (4)NN-Ver.+GMM: 9,890 sim, 8.3+415.5 min; (5)NN-Ver.+NN: 3,378 sim, 1.73+155.9 min; (6) NN+GMM: 3,846 sim, 1.9+125.5 min; (7)NN-Ver.+NN+GMM: 7,862 sim, 21.8+405.9 min.

Next, the second phase's flexibility was illustrated by improving an intermediate (not from the NDF) solution from the first phase obtained using NN-Ver.+NN-based injections. The aim was to enhance its performance while ensuring that it dominates the ASSENT technique's solution. The time constraint was modified to 3.5 from 10.0 to obtain solutions with lower time than that obtained using ASSENT. The ASSENT solution is shown using a black ‘+’ in the bottom row of FIG. 10C. The time and number of simulations required in the second phase in this case are (1)NN-Ver: 6,687 sim, 9.3+286.1 min; (2) GMM: 6,977 sim, 5.5+176.3 min; (3) NN: 3,155 sim, 2.0+154.8 min; (4)NN-Ver.+GMM: 4,120 sim, 3.2+128.3 min; (5)NN-Ver.+NN: 6,259 sim, 10.1+277.7 min; (6) NN+GMM: 8,808 sim, 7.6+332.5 min; (7)NN-Ver.+NN+GMM: 7,890 sim, 8.5+280.1 min.

Table I, below, compares results from INFORM with results from an ASSENT technique for Lunar Lander. The top half of the table shows a solution obtained using NN-Ver.+GMM injections in the first phase. Using NN-Ver.+NN-based inverse design in the second phase yield solutions that dominate the first phase solution in two different runs. The bottom half of the table shows results of using the second phase to enhance the first phase solution so that it further dominates the ASSENT solution. NN-Ver.+NN+GMM-based inverse design yields a solution that consumes 6× lower fuel and a comparable performance in other metrics. NN-Ver.+GMM-based inverse design yield solutions that has 2× lower fuel and a 1.2% higher reward than the ASSENT solution.

TABLE I

| Method | # Sim | Sim + Alg Time | Fuel | Time ≤ 10 | Reward |
|---|---|---|---|---|---|
| ASSENT | 1,983 | 54.042 s | 47.09 | 3.50 | 475.7 |
| Phase 1 | 4,543 | 409 + 6.648 s | 40.73 | 3.44 | 472.9 |
| (NN-Ver + GMM) | | | | | |
| Phase 2 | 3,378/ | 104 + 9.353/ | 32.90/ | 3.52/3.12 | 482.4/ |
| (NN-Ver + NN) | 6,780 | 870 + 21.633 s | 32.80 | | 480.8 |
| Phase 1 | 7.439 | 962 + 13.899 s | 22.0 | 3.26 | 477.4 |
| (NN-Ver + NN) | | | | | |
| Phase 2 (NN-Ver + | 7,890 | 507 + 16.804 s | 8.10 | 2.32 | 479.0 |
| NN + GMM) | | | | | |
| Phase 2 | 4,120/ | 190 + 7,700/ | 22.44/ | 3.34/3.22 | 481.6/ |
| (NN-Ver + GMM) | 7,532 | 684 + 13.653 s | 23.93 | | 480.8 |

### Example 4 (Two-Stage Transimpedance Amplifier)

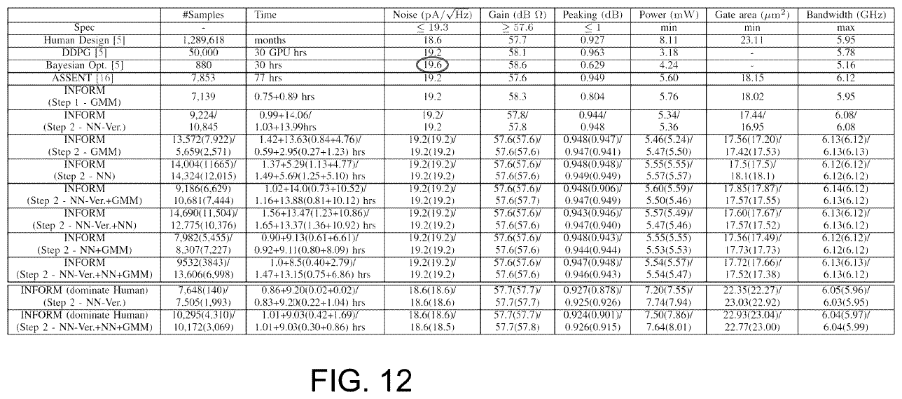

In this example, a two-stage transimpedance amplifier was optimized, using a topology as seen in FIG. 11A. In this example, the designer needs to determine the width of all MOSFETs and the two resistors shown in FIG. 11A. The search space for the width of each MOSFET is in the [0.18, 80] μm and the resistor in the [50, 5k] Ω range. When running GA, the three objectives used were:
1) Bandwidth: This example captured all the metrics (gain, peaking, and bandwidth) corresponding to the frequency response into one objective. In addition, it included the operating mode of the MOSFET in this objective as well. The processor(s) obtained the objectives corresponding to the frequency response as follows. (1) It set the target gain to 60 dB with a cutoff frequency of 6.1 GHz. It defined the first sub-objective as the difference in the target response and the observed response. In order to focus more on the response in the passband, it added an additional term to the difference. This additional term is 40 times the difference between the target and the observed response in the passband. (2) The processor(s) penalizes the gain by α=15 determined by the fractional deviation of the difference in gain below 58.1 dBΩ. The processor(s) added a penalty of 15 based on the fractional deviation in peaking above 0.963. (4) Similarly, processor(s) added a penalty of 15 if the observed bandwidth is below 5.81 GHz. Processor(s) also penalized the frequency response based on the operating region of the MOSFET. The processor(s) gives a reward of 1 for each MOSFET operating in the saturation region. The processor(s) penalize by 2(3) an operation in the linear (cutoff) region. The processor(s) sums the rewards and penalties and divide by the number of MOSFETs in the circuit. These rewards and penalties are used to encourage MOSFETs to operate in the saturation region for the circuit to behave as an amplifier. The processor(s) sums all the subobjectives for the frequency response and scale it by the objective value of the human-designed circuit in Wang, H., et al., “Learning to design circuits,” in NeurIPS Machine Learning for Systems Workshop, 2018.
2) Noise: We define the noise objective as the ratio of the measured noise and the noise corresponding to the RL circuit in Wang. (19.2 pA/√Hz). If the measured noise is above 19.2 pA/√Hz, the processor(s) apply a penalty of 15 determined by the fractional deviation above this value.
3) Power: The designer defined the objective corresponding to power as the ratio of the measured power and the power achieved by the RL circuit in Wang (3.18 mW).

If the simulation is unsuccessful, processor(s) set the objective values to a very large number to indicate this fact. Processor(s) use prior knowledge and assume a design is invalid if the power consumption is less than 0.1 μW.

As inverse design methods can handle multiple objectives and constraints, the processor(s) in this example consider all objectives and constraints independently, instead of clubbing them together. The goal of the inverse design is to meet the three constraints and optimize the three objectives. The constraints are: noise≤19.3 pA/√Hz, gain ≥57.6 dB Ω, and peaking≤1 dB. The objectives are: minimize power, minimize area, and maximize bandwidth. The processor(s) clip des_obj_ctr corresponding to the objectives of the solution around which they generate samples to ensure that they improve all objective values simultaneously and satisfy the constraints. For example, if the processor(s) sample around an objective and constraint with a value of [19.2 pA/√Hz, 57.7 dBΩ, 0.95 dB, 6.0 mW, 20 μm2, 6.1 GHz] and generate a des_obj_ctr [19.3 pA/√Hz, 57.7 dB (2, 0.98 dB, 6.2 mW, 19.5 μm2, 6.12 GHz], the processor(s) clip des_obj_ctr to [19.3 pA/√Hz, 57.7 dBΩ, 0.98 dB, 6.0 mW, 19.5 μm2, 6.12 GHz]. Note that des_obj_ctr satisfies all constraints and is better or the same (power) in all objective values than the solution around which the designer generates the desired objectives and constraints. It was found that clipping the objective values worked well on electrical circuit examples.

An NN was selected with one of the following architectures: [(15), (30), (40,20,8)]. FIG. 11B shows the NDF for bandwidth vs. power obtained in the first phase. To enhance readability, the graph only plots the NDF of the union of all simulations obtained from the eight methods in the first phase. Injecting GA with candidate solutions using inverse designs leads to most of the solutions on the NDF. FIG. 11C plots hypervolume vs. #generations. It is observed that inverse design injections using GMM and NN-Ver.+GMM achieve similar hypervolume, with the latter converging the fastest. The number of simulations and time (sim.+alg.) needed for each synthesis methodology are as follows: (1) GA: 7,873 sim, 58.5+0.8 min; (2)NN-Ver: 3,798 sim, 24.8+69.9 min; (3) GMM: 7,139 sim, 45.3+53.2 min; (4) NN: 5,637 sim, 36.4+31.6 min; (5)NN-Ver.+GMM: 5,745 sim, 37.1+135.7 min; (6)NN-Ver.+NN: 9,326 sim, 61.7+226.1 min; (7) NN+GMM: 5,353 sim, 34.4+60.3 min; (8) NNVer.+NN+GMM: 5,162 sim, 32.9+61.5 min.

In the second phase, the processor(s) are configured to use inverse designs to dominate the solution selected from the NDF in the first phase. It also generates a solution that is better or the same in all objectives and constraints compared to the solution obtained using ASSENT technique. The processor(s) are configured to run the second phase for a maximum of 10 (15) hours when generating a solution to dominate the first phase (ASSENT) solution. The processor(s) improve the bandwidth value and restrict the area and power to the values of the solution chosen in the first phase. The top row of FIGS. 11D-11F show the NDF of the solutions that dominate the first phase solution, depicted with a black circle. The number of simulations and the time (sim.+alg.) required in the second phase corresponding to the solution from the first phase are as follows: (1)NN-Ver: 4,754 sim, 36+565 min; (2) GMM: 8,018 sim, 53+548 min; (3) NN: 14,383 sim, 93+245 min; (4)NN-Ver.+GMM: 7,679 sim, 50+553 min; (5)NN-Ver.+NN: 9,989 sim, 80+523 min; (6) NN+GMM: 9,758 sim, 62+539 min; (7)NN-Ver.+NN+GMM: 7,315 sim, 59+551 min. Note that all inverse design methods yield solutions that dominate the first phase solution. However, the inverse design solutions using the five inverse design methods shown in the top row of FIGS. 11D-11F dominate the solutions obtained using the remaining two inverse design methods. Therefore, these graphs do not plot the solutions obtained using all the seven methods.

In the second experiment, INFORM's flexibility is demonstrated by searching around the same solution selected in the first phase, but changing the goal to obtain solutions that dominate the solution obtained using ASSENT in all objectives and constraints. The designer set noise, gain, peaking, power, and area to constraints corresponding to the solution obtained using the ASSENT technique and improve the bandwidth value. The bottom row of FIGS. 11D-11F shows the ASSENT solution using a black ‘+’ sign.

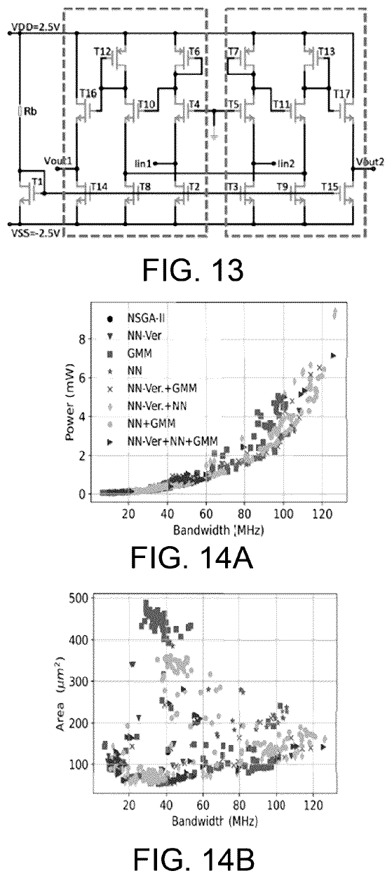

In FIG. 12, the solution obtained using INFORM for two different runs is compared with the solutions using other methodologies. In the table, the first solution that dominates the ASSENT solution is shown in parentheses. The number outside the parentheses shows the solution obtained at the end of the second phase.

INFORM achieves a speed-up of up to 24× (GMM second run) in synthesizing a solution with 3.4% lower area and a similar performance in other objectives/constraints as the ASSENT solution. In the bottom half of the table, only the second phase is used to drive the human solution from Wang to further enhance its performance (objectives+constraints). INFORM yields solutions that have a higher bandwidth and are better or the same in other performance metrics.

### Example 5 (Three-Stage Transimpedance Amplifier)

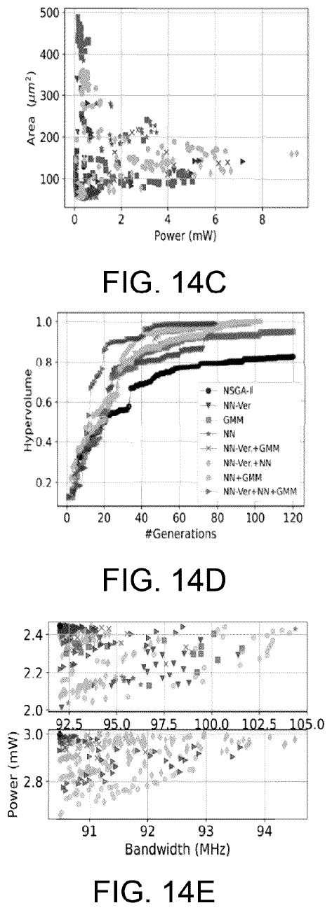

This example considers how one can select the component values of a three-stage transimpedance amplifier as shown in FIG. 13. The subcircuits in the dotted boxes are mirror images of each other. Hence, one can select the component values of one subcircuit and mirror them to the other. Here, the processor(s) determine the values of 19 components: width/length of nine MOSFETs, and a resistor Rb. The search space for the MOSFET's width is in the [2, 30] μm, length in the [1, 2.2] μm, and resistor in the [50k, 500k]Ω range. As the technology permits length to be an integer multiple of 0.2 μm, the processor(s) round the length to the nearest 0.2 units.

The designer selects the following objectives for the GA:
1) Bandwidth: As in Example 4, the processor(s) capture the metrics corresponding to the frequency response into one objective. The processor(s) set the target gain for the half circuit to be 85 dB with a cutoff frequency of 90 MHz. The same technique (with the modified gain and cutoff frequency) as used in Example 4 is used to compute the first sub-objective to capture the frequency response, and the same method as in Example 4 was used to compute the sub-objective corresponding to the operating region of the MOSFET, except using a penalty of 5 (7) for MOSFET operation in linear (cutoff) region. The third sub-objective is a penalty of 15 for fractional deviation in gain below 80 dB for the half circuit in FIG. 13.
2) Area: The processor(s) take ratio of the area of the circuit synthesized in the first phase using GA and the area of the human-synthesized circuit from Wang.
3) Power: The processor(s) take the ratio of the measured power to the power consumed by the human-synthesized circuit (1.37 mW) from Wang. The processor(s) uses a penalty of 15 for fractional deviation in power above 1.37 mW.

The processor(s) generate candidate solutions using the inverse design methods by setting des_obj_ctr to maximize bandwidth, minimize power, and minimize area subject to the constraint on gain being greater than 80 dB.

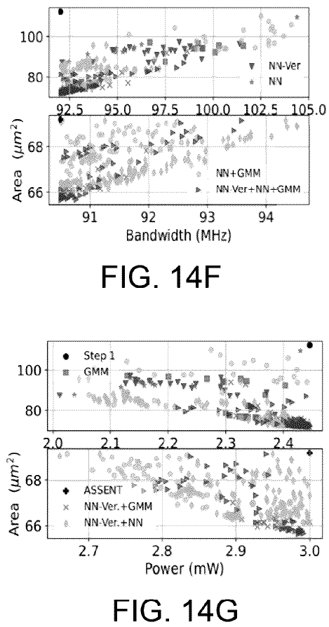

FIGS. 14A-14C show the NDFs related to power, bandwidth, and area in the first phase. Note that some of the solutions have large area, as shown in FIG. 14B. However, they have a better power or bandwidth and lie on the NDF. FIG. 14D shows the hypervolume obtained using the eight methods in the first phase. The number of simulations and time (sim.+alg.) needed for each synthesis methodology are as follows: (1) GA: 11,415 sim, 78.1+0.9 min; (2)NN-Ver: 7,496 sim, 56.6+122.0 min; (3) GMM: 11,804 sim, 76+62.5 min; (4) NN: 11,189 sim, 69.9+95.3 min; (5)NN-Ver.+GMM: 9,510 sim, 59.5+103.4 min; (6)NN-Ver.+NN: 8,696 sim, 54.5+115.1 min; (7) NN+GMM: 10,104 sim, 71.0+116.7 min; (8)NN-Ver.+NN+GMM: 7,778 sim, 55.2+145.9 min.

The top row of FIGS. 14E-14G depict the first phase solution with a black circle. This is dominated using the inverse design methods in the second phase. The number of simulations and the time (sim.+alg.) required in the second phase are as follows: (1)NN-Ver: 6,667 sim, 2,446+10,697s; (2) GMM: 8,980 sim, 3,609+18,499s; (3) NN: 15,785 sim, 5,578+30,549s; (4)NN-Ver.+GMM: 9,563 sim, 3,716+32,773s; (5)NN-Ver.+NN: 14,910 sim, 5,430+30,737s; (6) NN+GMM: 6,650 sim, 2,409+9,338s; (7)NN-Ver.+NN+GMM: 11,024 sim, 4,130+32,322s.

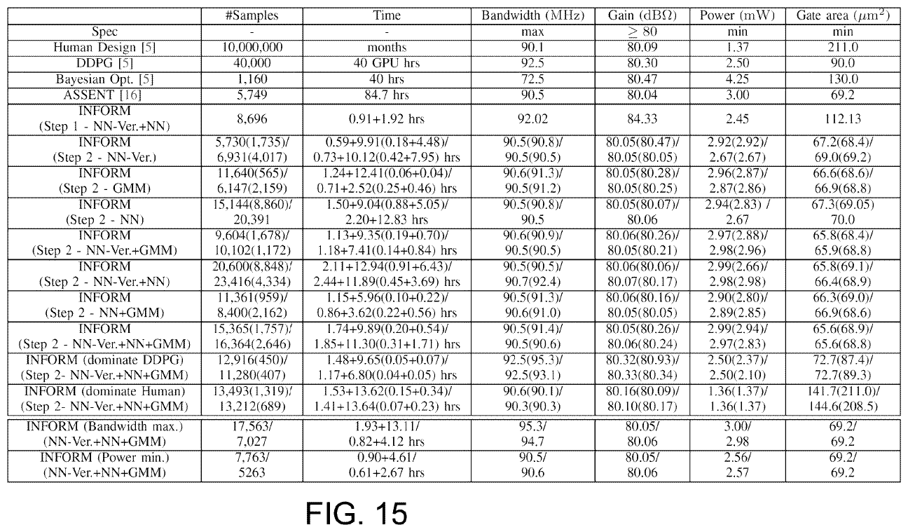

The bottom row of FIGS. 14E-14G show the solution from ASSENT using a ‘+’ sign. It is observed that several inverse design solutions lie on the NDF. In the top part of the table shown as FIG. 15, the solution obtained using INFORM is compared with the solutions using other methodologies. It is observed that INFORM achieves a speedup of up to 29× (GMM first run in the second phase) for synthesis of a design comparable to ASSENT. NN-Ver.+NN+GMM generates a solution with 5.2% lower area and a similar power, gain, and bandwidth compared to the ASSENT solution, however, at a reduced speed-up of 6×. The second phase of INFORM is also used to drive the first phase DDPG (and human) solution to be better in all the performance metrics (objectives+constraints) than the DDPG (and human) solution in Wang. When synthesizing the solution that dominates the human design, the search space is changed to lie within ±50% of the human design. The solution obtained using INFORM has about 19% (33%) lower area, and similar performance in other metrics in comparison to the DDPG (human) design.

Next the second phase is used to drive one solution to another solution. The bottom half of the table in FIG. 15 shows results when the first INFORM solution generated by GMM that dominates the ASSENT solution is driven to another solution. Here, the aim is to decrease (increase) power (bandwidth) while setting other constraints to match that of the ASSENT solution. The additional samples/time required are shown with respect to the GMM solution obtained in the second phase. It is observed that power (bandwidth) is 14.7% (5.3%) lower (higher) than the ASSENT solution.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements, and hyperparameters are presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed:

1. A computer-implemented method for performing constrained multi-objective optimization of a system, comprising:
a phase comprising:
i) receiving a selected reference solution, the selected reference solution including an input and a corresponding output, the selected reference solution being identified as a current best observed solution;
ii) determining or receiving a selection of an objective of the selected reference solution to be improved;
iii) generating and simulating multiple inputs within a first predetermined fraction of the input corresponding to the current best observed solution:
iv) training one or more surrogate models using previously determined inputs and system responses;
v) generating a plurality of desired system responses within a second predetermined fraction around the current best observed solution, each desired system response of the plurality of desired system responses improving the objective that was determined or selected in ii), each desired system response of the plurality of desired system responses satisfying existing constraints on the system response;
vi) using one or more of a plurality of inverse design approaches to generate candidate solutions at the desired system response generated in v);
vii) simulating the candidate solutions to provide one or more resulting solutions;
viii) determining if any resulting solutions improve the objective that was determined or selected in ii) and, based on the result, updating the current best observed solution; and
ix) repeating steps iv)-viii).

2. The computer-implemented method according to claim 1, further comprising determining if the current best observed solution has improved in a first predetermined number of iterations, and if not, reducing the value of the second predetermined fraction prior to repeating steps iv)-viii).

3. The computer-implemented method according to claim 2, further comprising determining if the current best observed solution has improved in a second predetermined number of iterations, and if not, reducing the first predetermined fraction and repeating steps iii)-viii).

4. The computer-implemented method according to claim 3, further comprising determining if the current best observed solution has not improved for a predetermined period of time or has not improved for a predetermined number of iterations, and if it is determined no such improvement has occurred, stop repeating steps iii)-viii) or steps iv)-viii).

5. The computer-implemented method according to claim 1, wherein inverse design-based active learning comprises generating a desired system response using Sobol and Latin Hypercube samples to gradually improve quality of resulting solutions, where the desired system response includes objectives and/or constraints.

6. The computer-implemented method according to claim 5, wherein candidate solutions within a generation consists of a mixture of solutions generated using crossover/mutation and solutions generated using an inverse design approach of the plurality of inverse design approaches.

7. The computer-implemented method according to claim 1, wherein the plurality of inverse design approaches including a neural network (NN), a NN verifier (NN-Ver), a Gaussian mixture model (GMM), and/or one or more combinations thereof.

8. The computer-implemented method according to claim 7, wherein an inverse design approach of the plurality of inverse design approaches comprises specifying a desired system response as outputs of the NN, and determining corresponding inputs after solving a mixed integer linear program formulation of the NN using the NN-Ver.

9. The computer-implemented method according to claim 7, wherein an inverse design approach of the plurality of inverse design approaches comprises a NN mapping a system response to system inputs, and wherein candidate solutions are generated by specifying a desired system response as inputs to the NN and determining corresponding NN output, where the system response includes an objective and/or constraint.

10. The computer-implemented method according to claim 7, wherein an inverse design approach of the plurality of inverse design approaches comprises considering the joint distribution of values of inputs and corresponding objectives and/or constraints, and wherein candidate solutions are generated by computing an expected value of an input given a desired system response.

11. The computer-implemented method according to claim 10, further comprising using a probability density function computed of the candidate solutions for the desired system response as a measure of confidence of the solution achieving the desired system response.

12. The computer-implemented method according to claim 1, further comprising an initial optional phase comprising:
obtaining a set of a set of non-dominated solutions by injecting candidate solutions within a genetic algorithm (GA) using the plurality of inverse design approaches; and
generating and simulating a plurality of candidate solutions within a predetermined range of component values,
wherein the selected reference solution is a candidate solution of the plurality of candidate solutions.

13. The computer-implemented method according to claim 12, where in the candidate solutions start to be injected when no improvement in extreme values of an objective function is determined for n consecutive generations within the GA, where n≥2.

14. The computer-implemented method according to claim 12, where the initial optional phase is terminated when either:
no improvement in extreme values of an objective function is determined for n consecutive generations within the GA after a threshold generation, where n≥2 and the threshold generation ≥2: or
the initial optional phase has been executing on one or more processors for more than a threshold period of time.

15. The computer-implemented method according to claim 12, wherein the initial optional phase is configured to achieve a higher hypervolume as compared to population based optimization using a NSGA-II algorithm.

16. The computer-implemented method according to claim 1, wherein the system for optimization has a fixed architecture.

17. The computer-implemented method according to claim 1, wherein the system for optimization includes one or more electric circuits.

18. The computer-implemented method according to claim 1, further comprising identifying a chosen solution from the one or more resulting solutions and outputting the chosen solution in a format appropriate for implementing the chosen solution.

19. The computer-implemented method according to claim 1, wherein using one or more of the plurality of inverse design approaches to generate candidate solutions includes simultaneously generating multiple user-specified candidate solutions.

20. The computer-implemented method according to claim 1, wherein determining if any resulting solutions improve the objective that was determined or selected in ii) includes directly handling multiple objectives and/or constraints based on simulation inputs and outputs, and the determination is free of any use of a pseudometric.

21. The computer-implemented method according to claim 1, wherein the method is configured to be performed without the use of any graphical processing unit (GPU).

22. The computer-implemented method according to claim 1, wherein the method is configured to drive the reference solution to a different specification.

23. The computer-implemented method according to claim 1, further comprising dynamically adjusting an improvement in desired performance until performance saturation is achieved.

24. The computer-implemented method according to claim 23, wherein the desired performance is generated using one or more of the plurality of inverse design approaches to ensure the performance improves in a user-selected objective, and the performance is better or the same in other objectives while satisfying all constraints on the system response.

25. The computer-implemented method according to claim 1, further comprising outputting a set of solutions that dominates the selected reference solution.

26. A non-transitory computer-readable storage medium comprising processor-executable instructions configured to cause a processor to perform a computer-implemented method according to claim 1.

27. A system, comprising:
a non-transitory computer-readable storage medium; and
a first processor operably coupled to the non-transitory computer-readable storage medium, the first processor configured to execute processor-executable instructions stored on the non-transitory computer-readable storage medium to perform a computer-implemented method according to claim 1.

28. The system according to claim 27, further comprising a second processor, the second processor configured to receive instructions from a user, send the instructions to the first processor, receive the one or more resulting solutions from the first processor, reformat the one or more resulting solutions to a user-selected format, and display the user-selected format to the user.

29. The system according to claim 28, wherein the user-selected format is defined by a selection of component values of a given circuit.
